(19) United States
(12) Patent Application Publication
(10) Pub. No.: US 2020/0380250 A1
(43) Pub. Date: Dec. 3, 2020

(54) IMAGE PROCESSING METHOD AND APPARATUS, AND COMPUTER STORAGE MEDIUM

(71) Applicant: BEIJING SENSETIME TECHNOLOGY DEVELOPMENT CO., LTD., Beijing (CN)

(72) Inventors: Wentao LIU, Beijing (CN); Chen QIAN, Beijing (CN); Chen CHEN, Beijing (CN)

(21) Appl. No.: 16/999,204

(22) Filed: Aug. 21, 2020

Related U.S. Application Data
(63) Continuation of application No. PCT/CN2019/107353, filed on Sep. 23, 2019.

(30) Foreign Application Priority Data
Sep. 21, 2018 (CN) 201811110229.5

(51) Int. Cl. G06K 9/00; G06K 9/32; G06T 7/149; G06T 7/55

(52) U.S. Cl. CPC G06K 9/00355; G06K 9/00201; G06T 7/55; G06T 7/149; G06K 9/3241

(57) ABSTRACT

An image processing method and apparatus, and a computer storage medium are provided. The method includes: obtaining a first image, recognizing a target object in the first image, acquiring a first target area of the target object, and acquiring a second target area associated with the first target area; and performing image deformation processing on the first target area and simultaneously performing image deformation processing on the second target area, to generate a second image.

### CROSS-REFERENCE TO RELATED APPLICATIONS

The present application is a continuation of International Patent Application No. PCT/CN2019/107353, filed on Sep. 23, 2019, which claims priority to Chinese Patent Application No. 201811110229.5, filed on Sep. 21, 2018. The disclosures of International Patent Application No. PCT/CN2019/107353 and Chinese Patent Application No. 201811110229.5 are hereby incorporated by reference in their entireties.

### BACKGROUND

With the rapid development of Internet technologies, various image processing tools emerge to process target objects in images, for example, performing “body shaping” on a target person in an image by performing operations of deformation such as local enlargement or thinning, including “leg shaping”, “arm shaping”, “waist shaping”, and “shoulder shaping”, thereby perfecting the body shape of the person. However, such local deformation processing is only intended for a local area of the target person, which always results in overall incoordination of the target person after the local deformation processing.

### SUMMARY

Embodiments of the present disclosure provide an image processing method and apparatus and a computer storage medium. The technical solutions of the embodiments of the present disclosure are implemented as below.

The embodiments of the present disclosure provide an image processing method, including: acquiring a first image, recognizing a target object in the first image, acquiring a first target area of the target object, and acquiring a second target area associated with the first target area; and performing image deformation processing on the first target area and simultaneously performing image deformation processing on the second target area, to generate a second image.

The embodiments of the present disclosure also provide a computer-readable storage medium having a computer program stored thereon, where the program, when being executed by a processor, enables to implement the steps of the method according to the embodiments of the present disclosure.

The embodiments of the present disclosure provide an image processing apparatus, including: a processor; and a memory configured to store a computer program executable by the processor, where the processor is configured to implement, upon execution of the program, implement the steps of the method according to the embodiments of the present disclosure.

### BRIEF DESCRIPTION OF THE DRAWINGS

FIG. 1 is a first schematic flowchart of an image processing method according to embodiments of the present disclosure.

FIG. 2 is a second schematic flowchart of an image processing method according to embodiments of the present disclosure.

FIG. 3 is a schematic structural composition diagram of an image processing apparatus according to embodiments of the present disclosure.

FIG. 4 is a schematic structural hardware composition diagram of an image processing apparatus according to embodiments of the present disclosure.

### DETAILED DESCRIPTION

The present disclosure is further described in detail below with reference to the accompanying drawings and specific embodiments.

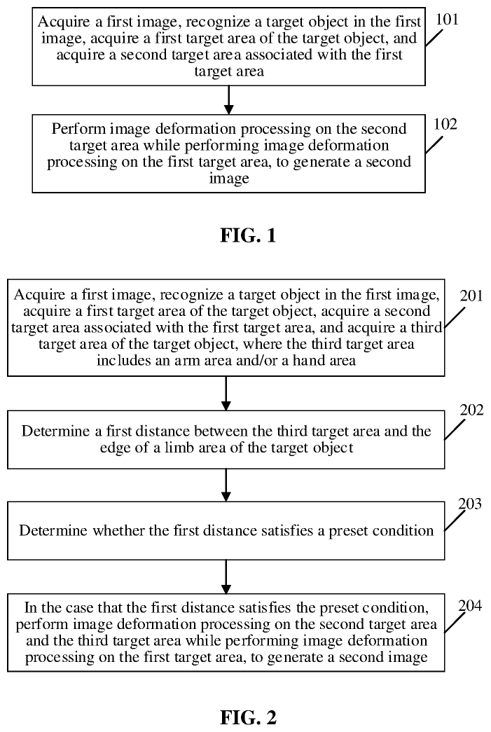

Embodiments of the present disclosure provide an image processing method. FIG. 1 is a schematic flowchart of an image processing method according to embodiments of the present disclosure. As shown in FIG. 1, the method includes the following steps.

At step 101, a first image is acquired, a target object in the first image is recognized, a first target area of the target object is acquired, and a second target area associated with the first target area is acquired.

At step 102, image deformation processing is performed on the first target area and simultaneously image deformation processing is performed on the second target area, to generate a second image.

According to the image processing method of the embodiments, the target object in the first image is recognized; and the target object, as an object to be processed, may be a real character in the image. In other implementations, the target object may also be a virtual character, such as a cartoon character. Of course, the target object may also be other types of objects. No limitation is made thereto in the embodiments of the present disclosure.

In some embodiments, the target object in the first image is recognized through an image recognition algorithm; and a limb area corresponding to the target object includes at least one of: a head area, a shoulder area, a chest area, a waist area, an arm area, a hand area, a buttocks area, a leg area, a foot area, or the like.

In some embodiments, the first target area may be any one of the foregoing limb areas, for example, the first target area is the shoulder area or the waist area; and the second target area is an area associated with the first target area. As an example, the association between the first target area and the second target area is that a location relationship between the first target area and the second target area satisfies a specific condition. For example, the location relationship between the first target area and the second target area satisfying the specific condition refers to the first target area being adjacent to the second target area. For another example, the location relationship between the first target area and the second target area satisfying the specific condition refers to the distance between the first target area and the second target area being less than a preset threshold, where the distance between the first target area and the second target area is a pixel distance, and the preset threshold is related to the pixel size of the target object in the first image, exemplarily, the preset threshold is related to the pixel size of the width or length of the first target area.

In some implementations, the second target area is in contact with the first target area, where the second target area includes at least one limb area, and the at least one limb area has a limb area adjacent to the first target area. As an example, the first target area is the shoulder area, and the second target area is the waist area and the chest area; or the first target area is the waist area, and the second target area is the chest area and the shoulder area, or the second target area is the buttocks area and the leg area. Exemplarily, the limb area constituting a trunk part of the target object (i.e., a target person) includes the shoulder area, the chest area, and the waist area. When the shoulder area is taken as the first target area, the chest area and the waist area are taken as the second target area; or when the waist area is taken as the first target area, the chest area and the shoulder area are taken as the second target area.

In some implementations, the second target area is not adjacent to the first target area. As an example, the first target area is the shoulder area, and the second target area is the waist area; or the first target area is the waist area, and the second target area is the shoulder area, the leg area, or the like.

In some implementations, the operation of performing image deformation processing on the first target area and simultaneously performing image deformation processing on the second target area includes: performing image deformation processing on the first target area according to a first deformation parameter and simultaneously performing image deformation processing on the second target area according to a second deformation parameter, where the deformation degree of the first deformation parameter is higher than that of the second deformation parameter. The second deformation parameter changes with the distance between a pixel point in the second target area and the first target area.

In some embodiments, image deformation processing performed on the first target area and the second target area includes: image compression processing or image stretching processing. The image compression processing includes compression processing performed along a direction from two side edges of the first target area to a center line, and compression processing performed along a direction from two side edges of the second target area to the center line; and the degree of compression corresponding to the first target area is higher than the degree of compression corresponding to the second target area. The image stretching processing includes stretching processing performed along a direction from the center line of the first target area to the two side edges, and stretching processing performed along a direction from the center line of the second target area to the two side edges; and the degree of stretching corresponding to the first target area is higher than the degree of stretching corresponding to the second target area. It may be understood that the image compression processing is “thinning” processing, and the image stretching processing is “enlargement” processing.

In some embodiments, in the process of performing image deformation processing on the first target area, on the one hand, image deformation processing is performed on the first target area, such as the shoulder area or the waist area, and on the other hand, image deformation processing is performed on the second target area associated with the first target area. Therefore, in the process of performing image deformation processing on a local area (i.e., the first target area) of a target person, another area (i.e., the second target area) associated with the local area is also subjected to image deformation processing, correspondingly, thereby avoiding proportional incoordination caused by image deformation processing intended only for the local area.

In some embodiments, the deformation degree of the second target area is lower than that of the deformation parameter of the first target area. Taking a situation where the first target area is the shoulder area and the second target area is the chest area and the waist area as an example, the deformation degree represented by the first deformation parameter of the first target area is, for example, 100%, and the deformation degree represented by the second deformation parameter of the waist area is 50%. The minimum values of the first deformation parameter and the second deformation parameter may be preconfigured.

The deformation degrees represented by the second deformation parameters of different locations in the second target area are associated with the distances between the locations and the first target area. The distance between each one of the locations and the first target area may be the distance between the each one of the locations and the edge of the first target area. Still taking a situation where the first target area is the shoulder area and the second target area is the chest area and the waist area as an example, if the first deformation parameter corresponding to the first target area (i.e., the shoulder area) is, for example, 100%, and the second deformation parameter corresponding to a waist line location in the waist area in the second target area furthest away from the shoulder area is, for example 50%, then the second deformation parameter corresponding to an intermediate location in the second target area between the waist line location and the edge of the first target area is, for example, 75%. In this way, various expected target body shapes, such as a reverse-triangle body shape or other special body shapes, may be achieved according to actual requirements.

For another example, taking a situation where the first target area is the shoulder area and the second target area is the arm area as an example, if the distances between various points of the arm area and the shoulder area are linearly increased, i.e., a part where the arm area is connected to the shoulder area is closest to the shoulder area and a part where the arm area is connected to the hand area is furthest away from the shoulder part, the deformation parameters corresponding to various pixel points are gradually decreased from the first target area (i.e., the shoulder area) to the edge of the second target area furthest away from the shoulder area. Exemplarily, if the first deformation parameter corresponding to the first target area (i.e., the shoulder area) is, for example, 100%, and the second deformation parameter corresponding to the edge of the arm in the second target area furthest away from the shoulder area is, for example, 0%, the second deformation parameter corresponding to the intermediate location of the arm in the second target area is, for example, 50%. In this way, in the process of performing deformation processing on the shoulder area of the target area, adaptive deformation processing is performed on the arm area associated with the shoulder area, so as avoid that the shoulder is adjusted to be too thick and the arm is adjusted to be too thin, or the shoulder is adjusted to be too narrow and the arm is adjusted to be too thick. Therefore, the overall proportion of the target object is still coordinated even the local adjustment to the target object is made.

In some embodiments, the greater the distance between the pixel point in the second target area and the first target area is, the lower the deformation degree represented by the second deformation parameter corresponding to the pixel point in the second target area is. Exemplarily, still taking the situation where the first target area is the shoulder area and the second target area is the chest area and the waist area an example, the waist area is further from the shoulder area than the chest area, and thus the deformation degree of the waist area is lower than that of the chest area; furthermore, the deformation degree of a pixel point in the waist area far away from the chest area is lower than that of a pixel point close to the chest area, and the deformation degree of a pixel point in the chest far away from the shoulder area is lower than that of a pixel point close to the shoulder area. In actual applications, the pixel distances between various pixel points in the chest area and the waist area and a contour line of one side of the shoulder area can be determined, separately, and the deformation parameters corresponding to the pixel points are separately determined based on the pixel distances, where the deformation degree corresponding to the deformation parameter decreases as the pixel distance increases.

In some embodiments, image deformation processing is performed on the first target area and the second target area through the image deformation algorithm.

In some implementations, limb detection information of the target object in the first image is recognized; the limb detection information includes limb key point information and/or limb contour point information; the limb key point information includes coordinate information of a limb key point; and the limb contour point information includes coordinate information of a limb contour point.

Specifically, the limb detection information includes the limb key point information and/or the limb contour point information; the limb key point information includes the coordinate information of the limb key point; and the limb contour point information includes the coordinate information of the limb contour point. The limb contour point represents the limb contour of the limb area of the target object, i.e., the limb contour edge of the target object can be formed through the coordinate information of the limb contour point. The limb contour point includes at least one of: an arm contour point, a hand contour point, a shoulder contour point, a leg contour point, a foot contour point, a waist contour point, a head contour point, a buttocks contour point, or a chest contour point. The limb key point represents a skeleton key point of the target object, i.e., the main skeleton of the target object can be formed by connecting the limb key points according to the coordinate information of the limn key points. The limb key point includes at least one of: an arm key point, a hand key point, a shoulder key point, a leg key point, a foot key point, a waist key point, a head key point, a buttocks key point, or a chest key point.

Therefore, in some implementations, performing image deformation processing on the first target area includes: determining the contour line of the first target area based on the limb contour point information corresponding to the first target area; determining the center line of the first target area based on the limb contour point information corresponding to the first target area; performing compression processing on the first target area along a direction from the contour line to the center line; or performing stretching processing on the first target area along a direction from the center line to the contour line. Correspondingly, performing image deformation processing on the second target area includes: determining the contour line of the second target area based on the limb contour point information corresponding to the second target area; determining the center line of the second target area based on the limb contour point information corresponding to the second target area; performing compression processing on the second target area along a direction from the contour line to the center line; or performing stretching processing on the second target area along a direction from the center line to the contour line.

In some implementations, grid division is performed on the first image to acquire a plurality of grid control surfaces; image deformation processing is performed on the first target area based on a first grid control surface corresponding to the first target area; and image deformation processing is performed on the second target area based on a second grid control surface corresponding to the second target area.

In some implementations, the first image is averagely divided into N*M grid control surfaces, where N and M are positive integers, and are identical or different. For example, the target object in the first image is centered, grid division is performed on a rectangular area where the target object is located, and grid division is further performed on a background area excluding the rectangular area based on the grid division granularity of the rectangular area. In one embodiment, the number of the grid control surfaces is related to the proportion of the limb area, in the first image, corresponding to the target object in the first image. For example, one grid control surface corresponds to part of the limb area of the target object; for example, one grid control surface corresponds to the leg of the target object, or one grid control surface corresponds to the chest and the waist of the target object, so as to facilitate local deformation of the target object.

In some embodiments, the grid control surface in an initial state is rectangular, and the grid control surface also has a plurality of virtual control points (or control lines); and the curvature of each control line constituting the grid control surface is changed by moving the control point (or control line), so that the grid control surface is subjected to deformation processing. It can be understood that the grid control surface subjected to deformation processing is a curved surface.

For example, the grid control surface is specifically a catmull rom curved surface formed by catmull rom spline curves. The catmull rom spline curve has a plurality of control points, and it can be understood that the catmull rom curved surface is formed by a plurality of catmull rom spline curves. By moving at least some of the plurality of control points corresponding to any catmull rom spline curve, deformation processing of the catmull rom spline curve is achieved, and it can be understood that local deformation processing on the limb area corresponding to the catmull rom curved surface formed of a plurality of catmull rom spline curves is achieved by moving the control points of the plurality of catmull rom spline curves. Because the control point is on the catmull rom curve constituting the catmull rom curved surface, the curvature of the location of the control point and/or the location of the control point on the catmull rom curve is changed by moving the control point; and it can be understood that a certain point on the corresponding catmull rom curve or the curvature and/or location of the curve near the point can be changed by moving the control point, so that deformation processing of the local area in the catmull rom curved surface is realized, and thus the local deformation is more precise and the effect of image processing is improved.

Therefore, in the embodiments of the present disclosure, image deformation processing is performed on the first target area and the second target area by means of the grid control surfaces where the first target area and the second target area are respectively located.

By using the technical solution of the embodiments of the present disclosure, in the process of performing image deformation processing on a specific local area (the first target area), image deformation processing is also performed on another area (the second target area) associated with the local area, thereby avoiding proportional incoordination caused by image deformation processing intended only for the local area, greatly improving the effect of image deformation processing, and improving the operation experience of a user.

Based on the foregoing embodiments, embodiments of the present disclosure further provide an image processing method. FIG. 2 is another schematic flowchart of an image processing method according to embodiments of the present disclosure. As shown in FIG. 2, the method includes the following steps.

At step 201, a first image is acquired, a target object in the first image is recognized, a first target area of the target object is acquired, a second target area associated with the first target area is acquired, and a third target area of the target object is acquired, where the third target area includes an arm area and/or a hand area.

At step 202, a first distance between the third target area and the edge of a limb area of the target object is determined.

At step 203, whether the first distance satisfies a preset condition is determined.

At step 204, in the case that the first distance satisfies the preset condition, image deformation processing is performed on the first target area and simultaneously image deformation processing is performed on the second target area and the third target area, to generate a second image.

In some embodiments, for the mode of acquiring the third target area of the target object, refer to the mode of acquiring the first target area or the second target area in the foregoing embodiments. Details are not described herein again.

In some embodiments, different image deformation processing strategies are determined based on different distances between the third target area and the edge of the limb area of the target object. The limb area of the target object is any limb area of the target object, i.e., the limb area is not limited to the first target area or the second target area, and can also be any other limb areas.

In some implementations, determining whether the first distance satisfies the preset condition includes: determining whether a ratio of the first distance to the width of the first target area is less than a preset threshold; and in the case that the ratio of the first distance to the width of the first target area is less than the preset threshold, determining that the first distance satisfies the preset condition.

In the embodiments, the distance between the third target area and the edge of the limb area of the target object is an average distance between the edge of the third target area close to the limb area and the edge of the limb area. Taking a situation where the third target area is the arm area as an example, the distance between the third target area and the edge of the limb area of the target object is the average distance between the inner side edge of the arm area and the edge of the limb area. In actual applications, it can be realized by calculating the average value of the distances between contour points of the inner side edge of the arm and the edge of the limb area. Specifically, the foregoing distance may be the distance between pixel points, and can be represented by the number of pixel points between two pixel points; correspondingly, the width of the first target area can also be represented by the number of pixels.

Furthermore, the first distance is compared with the width of the first target area, i.e., in the embodiments, the width of the first target area is taken as a reference standard, so as to determine whether the third target area is close to or far away from the edge of the limb area of the target object. In actual applications, the preset threshold can be preconfigured, i.e., in the case that the ratio of the first distance to the width of the first target area is less than the preset threshold, it indicates that the third target area is close to the edge of the limb area, and correspondingly, in the case that the ratio of the first distance to the width of the first target area is greater than or equal to the preset threshold, it indicates that the third target area is far away from the edge of the limb area.

In the related art, a constant preset threshold is usually taken as the basis for measuring the distance between two objects, for example, a constant pixel threshold is taken as the basis for measuring whether the distance between the third target area and the edge of the limb area of the target object satisfies a preset condition. However, this manner may cause the following scenes: in image 1, if the distance between the third target area and the edge of the limb area of the target object exceeds the constant pixel threshold, the third target area is not processed in the process of performing image deformation processing on the first target area; and in image 2, the size of the target object in image 2 is the same as that in image 1, but the size of image 2 is greater than that of image 1, which is equivalent to that the proportion of the target object in image 2 is smaller, and then, in this scene, there may be a case that the distance between the third target area and the edge of the limb area of the target object does not exceed the constant pixel threshold, and thus adaptive image deformation processing is performed on the third target area in the process of performing image deformation processing on the first target area in image 2. In this way, this mode is not suitable for various image sizes or a scene where the proportion of the target object in the image varies. However, in the present implementation, the width of the first target area is taken as the basis for determining the distance between the third target area and the edge of the limb area of the target object. For example, if the first target area is a shoulder area and the third target area is the arm area, the width of the shoulder area is taken as the basis for determining the ratio of the distance between the arm area and the edge of the limb area to the width of the shoulder, and this ratio is taken as the basis for determining whether image deformation processing is performed on the third target area. This is suitable for different image sizes and pixel sizes of different target objects in the image.

In the embodiments, in the case that the ratio of the first distance to the width of the first target area is less than the preset threshold, i.e., when the third target area is close to the edge of the limb area of the target object, image deformation processing is performed on the second target area and the third target area in the process of performing image deformation processing on the first target area. Correspondingly, in the case that the ratio of the first distance to the width of the first target area is not less than the preset threshold, i.e., when the third target area is far away from the edge of the limb area of the target object, image deformation processing is performed on the second target are, but is not performed on the third target area, in the process of performing image deformation processing on the first target area.

Exemplarily, still taking a situation where the first target area is the shoulder area, the second target area is a chest area and a waist area, and the third target area is the arm area and a hand area as an example, the average distance (i.e. the first distance) between the inner side edge of the arm area and the hand area and the edge of a trunk area (including the chest area and the waist area) is determined; and in the case that a ratio of the average distance to the width of the shoulder area is less than a preset threshold, it indicates that the arm area and the hand area are close to the trunk area, and in the process of performing image deformation processing on the shoulder area, in addition to performing image deformation processing on the chest area and the waist area, image deformation processing is performed on the arm area and the hand area.

For image deformation processing of the first target area and the second target area, refer to the descriptions in the foregoing embodiments. Details are not described herein again.

For image deformation processing of the third target area, in some implementations, the third target area is divided into a first area and a second area based on a location relationship between the first target area and the second target area, where the first area corresponds to the first target area, and the second area corresponds to the second target area; and image deformation processing is performed on the first area according to a first deformation parameter, and image deformation processing is performed on the second area according to a second deformation parameter.

In some implementations, image deformation processing of the third target area is adapted to image deformation processing of the first target area and the second target area; that is, deformation processing is not performed on the width of the third target area (such as the arm area and the hand area), but, in the process of performing image deformation processing on the first target area and the second target area, the distance between the third target area and the limb area of the target object is adjusted, so that the third target area is far away from the limb area of the target object. Therefore, after image deformation processing of the first target area and the second target area, because the third target area is far away from the limb area of the target object, the overall deformation effect of the image does not become strange even though deformation processing is not performed on the third target area.

In some implementations, in the case that the first distance does not satisfy the preset condition, i.e., when the ratio of the distance between the third target area and the edge of the limb area of the target object to the width of the first target area is greater than or equal to the preset threshold, the third target area does not need to be considered, and in the process of performing image deformation processing on the first target area, image deformation processing is performed only on the second target area.

By using the technical solution of the embodiments of the present disclosure, according to the first aspect, in the process of performing image deformation processing on a specific local area (the first target area), image deformation processing is also performed on another area (the second target area) associated with the local area, thereby avoiding proportional incoordination caused by image deformation processing intended only for the local area, where a deformation parameter corresponding to the another area (such as the second target area) changes along with the distance between a pixel point in the another area and the local area (such as the first target area), for example, the greater the distance is, the lower the deformation degree represented by the corresponding deformation parameter is, i.e., the smaller the deformation is smaller. In this way, on the one hand, various expected deformation effects can be realized according to requirements; and on the other hand, the present disclosure is mainly intended for deformation processing for the local area, and by performing deformation processing on the another associated area according to a different deformation parameter, the effect of overall proportion coordination of the target object can be yielded.

According to the second aspect, the distance between the third target area and the edge of the limb area is detected, and when the third target area is close to the edge of the limb area, image deformation processing is performed on the second target area and the third target area in the process of performing image deformation processing on the first target area, so that the effect of image deformation processing is greatly improved and the operation experience of a user is improved. The width of the first target area is taken as the basis of the distance (i.e., the first distance) between the third target area and the edge of the limb area, i.e., determining whether the ratio of the first distance to the width of the first target area is less than the preset threshold; if the ratio of the first distance to the width of the first target area is less than the preset threshold, it indicates that the third target area is close to the limb area; and if the ratio of the first distance to the width of the first target area is greater than the preset threshold, it indicates that the third target area is far away from the limb area. This is suitable for various image sizes or a scene where images having the same size have target objects in different proportions. That is, the embodiments of the present disclosure are suitable for image deformation processing of a plurality of application scenes.

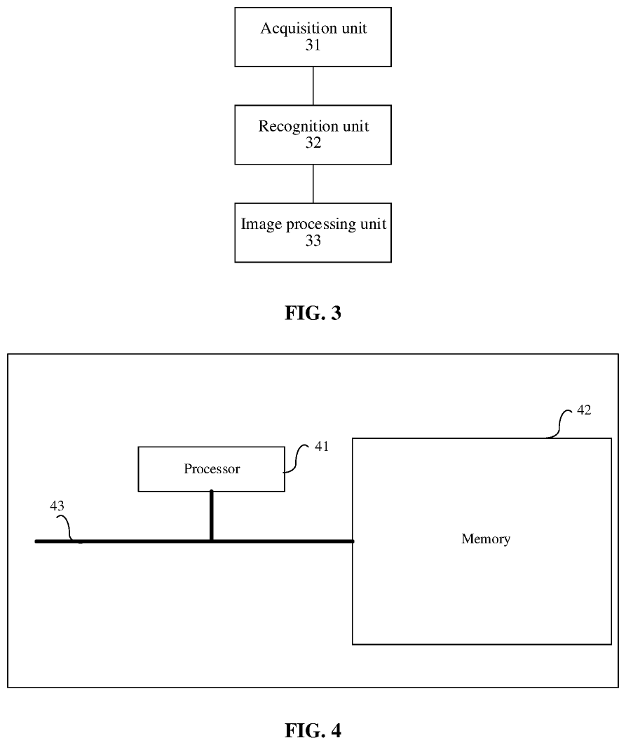

Embodiments of the present disclosure further provide an image processing apparatus. FIG. 3 is a schematic structural composition diagram of an image processing apparatus according to embodiments of the present disclosure. As shown in FIG. 3, the apparatus includes: an acquisition unit 31, a recognition unit 32, and an image processing unit 33.

The acquisition unit 31 is configured to acquire a first image;

the recognition unit 32 is configured to recognize a target object in the first image, acquire a first target area of the target object, and acquire a second target area associated with the first target area; and

the image processing unit 33 is configured to perform image deformation processing on the first target area and simultaneously perform image deformation processing on the second target area, to generate a second image.

In some optional embodiments of the present disclosure, the image processing unit 33 is configured to perform image deformation processing on the second target area according to a second deformation parameter in the process of performing image deformation processing on the first target area according to a first deformation parameter, where the deformation degree of the first deformation parameter is higher than that of the second deformation parameter.

In some embodiments, the second deformation parameter changes with the distance between a pixel point in the second target area and the first target area.

The greater the distance between the pixel point in the second target area and the first target area is, the lower the deformation degree represented by the second deformation parameter corresponding to the pixel point in the second target area is.

In some embodiments, the second target area includes at least one limb area; and the at least one limb area has a limb area adjacent to the first target area.

As an example, the first target area is a shoulder area, and the second target area is a waist area and/or a chest area; or the first target area is a waist area, and the second target area is a chest area and/or a shoulder area.

In some optional embodiments of the present disclosure, the recognition unit 32 is configured to recognize limb detection information of the target object in the first image, where the limb detection information includes limb key point information and/or limb contour point information.

The image processing unit 33 is configured to determine a contour line of the first target area based on the limb contour point information corresponding to the first target area; to determine a center line of the first target area based on the limb contour point information corresponding to the first target area; and to perform compression processing on the first target area along a direction from the contour line to the center line, or perform stretching processing on the first target area along a direction from the center line to the contour line.

In some optional embodiments of the present disclosure, the image processing unit 33 is configured to perform grid division on the first image to acquire a plurality of grid control surfaces; to perform image deformation processing on the first target area based on a first grid control surface corresponding to the first target area; and to perform image deformation processing on the second target area based on a second grid control surface corresponding to the second target area.

In some optional embodiments of the present disclosure, the recognition unit 32 is further configured to acquire a third target area of the target object, where the third target area includes an arm area and/or a hand area; and to determine a first distance between the third target area and the edge of the limb area of the target object.

The image processing unit 33 is further configured to determine whether the first distance satisfies a preset condition, and to, in the case that the first distance satisfies the preset condition, perform image deformation processing on the first target area and simultaneously perform image deformation processing on the second target area and the third target area, to generate the second image.

The image processing unit 33 is configured to determine whether a ratio of the first distance to the width of the first target area is less than a preset threshold; and to, in the case that the ratio of the first distance to the width of the first target area is less than the preset threshold, determine that the first distance satisfies the preset condition.

In some optional embodiments of the present disclosure, the image processing unit 33 is configured to divide the third target area into a first area and a second area based on a location relationship between the first target area and the second target area, where the first area corresponds to the first target area, and the second area corresponds to the second target area; and to perform image deformation processing on the first area according to the first deformation parameter, and perform image deformation processing on the second area according to the second deformation parameter.

In the embodiments of the present disclosure, in practical applications, the acquisition unit 31, the recognition unit 32, and the image processing unit 33 in the apparatus can all be implemented by a Center Processing Unit (CPU), a Digital Signal Processor (DSP), a Microcontroller Unit (MCU), or a Field-Programmable Gate Array (FPGA).

Embodiments of the present disclosure further provide an image processing apparatus. FIG. 4 is a schematic structural hardware composition diagram of an image processing apparatus according to embodiments of the present disclosure. As shown in FIG. 4, the image processing apparatus includes a memory 42, a processor 41, and a computer program that is stored on the memory 42 and can be run on the processor 41, where when the program is executed by the processor, the image processing method according to any one of the foregoing embodiments of the present disclosure is implemented.

It can be understood that various components in the image processing apparatus are coupled together through a bus system 43. It can be understood that the bus system 43 is used for implementing connection and communication between the components. In addition to a data bus, the bus system 43 further includes a power bus, a control bus, and a status signal bus. However, for clarity, the buses are all labeled as the bus system 43 in FIG. 4.

It can be understood that the memory 42 may be a volatile memory or a non-volatile memory, or may include both a volatile memory and a non-volatile memory. The non-volatile memory may be a Read Only Memory (ROM), a Programmable Read-Only Memory (PROM), an Erasable Programmable Read-Only Memory (EPROM), an Electrically Erasable Programmable Read-Only Memory (EEPROM), a Ferromagnetic Random Access Memory (FRAM), a flash memory, a magnetic surface memory, an optical disk, or a Compact Disc Read-Only Memory (CD-ROM), where the magnetic surface memory may be a magnetic-disk memory or a magnetic tape memory. The volatile memory may be a Random Access Memory (RAM), which acts as an external cache. By means of the exemplary but not limited description, the RAM is available in many forms, such as a Static Random Access Memory (SRAM), a Synchronous Static Random Access Memory (SSRAM), a Dynamic Random Access Memory (DRAM), a Synchronous Dynamic Random Access Memory (SDRAM), a Double Data Rate Synchronous Dynamic Random Access Memory (DDRSDRAM), an Enhanced Synchronous Dynamic Random Access Memory (ESDRAM), a SyncLink Dynamic Random Access Memory (SLDRAM), and a Direct Rambus Random Access Memory (DRRAM). The memory 42 described in the embodiments of the present disclosure is aimed at including, but not being limited to, these and any other suitable types of memories.

The method disclosed by the foregoing embodiments of the present disclosure can be applied to the processor 41, or can be implemented by the processor 41. The processor 41 may be an integrated circuit chip and has a signal processing capability. During implementation, the steps of the foregoing method can be completed by means of an integrated logic circuit of hardware in the processor 41 or instructions in the form of software. The processor 41 may be a general-purpose processor, a DSP, or other programmable logic devices, discrete gate or transistor logic devices, discrete hardware components or the like. The processor 41 can implement or execute the methods, the steps, and the logic block diagrams disclosed in the embodiments of the present disclosure. The general-purpose processor may be a microprocessor or any conventional processor. The steps of the methods disclosed with reference to the embodiments of the present disclosure can be directly executed and completed by a hardware decoding processor, or by a combination of hardware and software modules in a decoding processor. The software module may be located in a storage medium which is located in the memory 42. The processor 41 reads information in the memory 42 and completes the steps of the foregoing method in combination with hardware thereof.

It should be noted that: during image processing, the image processing apparatus provided in the foregoing embodiments is exemplified by division of the various program modules above. In practical applications, the processing above may be assigned to different program modules for implementation as needed. That is, the internal structure of the apparatus is divided into different program modules to implement all or part of the processing described above. In addition, the image processing apparatus provided in the foregoing embodiments and the image processing method embodiments relate to the same concept. Refer to the method embodiments for the specific implementation process of the image processing apparatus. Details are not described herein again.

In exemplary embodiments, the embodiments of the present disclosure further provide a computer readable storage medium, for example, the memory 42 including the computer program. The computer program can be executed by the processor 41 in the image processing apparatus to implement the steps of the foregoing method. The computer readable storage medium may be a memory such as the FRAM, the ROM, the PROM, the EPROM, the EEPROM, the flash memory, the magnetic surface memory, the optical disk, or the CD-ROM, and may also be any device including one or any combination of the foregoing memories, such as a mobile phone, a computer, a tablet device, and a personal digital assistant.

The embodiments of the present disclosure also provide a computer-readable storage medium having a computer instruction stored thereon, where when the instruction is executed by a processor, the image processing method according to any one of the foregoing embodiments of the present disclosure is implemented.

It should be understood that the disclosed device and method in the embodiments provided in the present disclosure may be implemented in other modes. The device embodiments described above are merely exemplary. For example, the unit division is merely logical function division and may be actually implemented in other division modes. For example, a plurality of units or components may be combined or integrated into another system, or some features may be ignored or not executed. In addition, the displayed or discussed mutual couplings or direct couplings or communicational connections among the components may be implemented by means of some interfaces. The indirect couplings or communicational connections between the devices or units may be implemented in electronic, mechanical, or other forms.

The units described as separate components may or may not be physically separate, and the components displayed as units may or may not be physical units, i.e., may be located at one position, or may be distributed on a plurality of network units. Some or all of the units are selected according to actual needs to achieve the purposes of the solutions of the embodiments.

In addition, the functional units in the embodiments of the present disclosure may be integrated into one processing unit, or each of the units may exist as an independent unit, or two or more units are integrated into one unit, and the integrated unit may be implemented in the form of hardware, or may be implemented in the form of a hardware and software functional unit.

A person of ordinary skill in the art may understand that all or some steps for implementing the foregoing method embodiments may be completed by a program by instructing related hardware; the foregoing program can be stored in a computer-readable storage medium; when the program is executed, steps including the foregoing method embodiments are executed. Moreover, the foregoing storage medium includes various media capable of storing a program code, such as a mobile storage device, the ROM, the RAM, the magnetic disk, or the optical disk.

Or, when the foregoing integrated units of the present disclosure are implemented in the form of software functional modules and sold or used as an independent product, the integrated units may be stored in a computer-readable storage medium. Based on such an understanding, the technical solutions of the embodiments of the present disclosure or the part thereof contributing to the prior art may be essentially embodied in the form of a software product. The computer software product is stored in one storage medium and includes several instructions so that one computer device (which may be a personal computer, a server, a network device, and the like) implements all or part of the method of the embodiments of the present disclosure. Moreover, the storage medium above includes various media capable of storing a program code, such as the mobile storage device, the ROM, the RAM, the magnetic disk, or the optical disk.

The descriptions above are only specific implementations of the present disclosure. However, the scope of protection of the present disclosure is not limited thereto. Within the technical scope disclosed by the present disclosure, any variation or substitution that can be easily conceived of by those skilled in the art should all fall within the scope of protection of the present disclosure. Therefore, the scope of protection of the present disclosure should be determined by the scope of protection of the claims.

1. An image processing method, comprising: acquiring a first image;
recognizing a target object in the first image, acquiring a first target area of the target object, and acquiring a second target area associated with the first target area; and
performing image deformation processing on the first target area and simultaneously performing image deformation processing on the second target area, to generate a second image.

2. The method according to claim 1, wherein performing image deformation processing on the first target area and simultaneously performing image deformation processing on the second target area comprises:
performing image deformation processing on the first target area according to a first deformation parameter and simultaneously performing image deformation processing on the second target area according to a second deformation parameter, wherein
the first deformation parameter has a deformation degree higher than that of the second deformation parameter.

3. The method according to claim 2, wherein the second deformation parameter changes with a distance between a pixel point in the second target area and the first target area.

4. The method according to claim 3, wherein the greater the distance between the pixel point in the second target area and the first target area is larger, the deformation degree represented by the second deformation parameter corresponding to the pixel point in the second target area is lower.

5. The method according to claim 1, wherein the second target area comprises at least one limb area; and the at least one limb area has a limb area adjacent to the first target area;
wherein the first target area is a shoulder area, and the second target area is at least one of a waist area or a chest area; or the first target area is a waist area, and the second target area is at least one of a chest area or a shoulder area.

6. The method according to claim 1, wherein recognizing the target object in the first image comprises: recognizing limb detection information of the target object in the first image, wherein the limb detection information comprises at least one of limb key point information or limb contour point information; and
performing image deformation processing on the first target area comprises: determining a contour line of the first target area based on the limb contour point information corresponding to the first target area;
determining a center line of the first target area based on the limb contour point information corresponding to the first target area; and
performing compression processing on the first target area along a direction from the contour line to the center line, or performing stretching processing on the first target area along a direction from the center line to the contour line.

7. The method according to claim 1, wherein before performing image deformation processing on the first target area, the method further comprises: performing grid division on the first image to acquire a plurality of grid control surfaces;
performing image deformation processing on the first target area comprises: performing image deformation processing on the first target area based on a first grid control surface corresponding to the first target area; and
performing image deformation processing on the second target area comprises: performing image deformation processing on the second target area based on a second grid control surface corresponding to the second target area.

8. The method according to claim 1, wherein the method further comprises:
acquiring a third target area of the target object, wherein the third target area comprises at least one of an arm area or a hand area;
determining a first distance between the third target area and an edge of a limb area of the target object; and
determining whether the first distance satisfies a preset condition; and
performing image deformation processing on the first target area and simultaneously performing image deformation processing on the second target area, to generate the second image comprises:
in the case that the first distance satisfies the preset condition, performing image deformation processing on the first target area and simultaneously performing image deformation processing on the second target area and the third target area, to generate the second image.

9. The method according to claim 8, wherein determining whether the first distance satisfies the preset condition comprises: determining whether a ratio of the first distance to a width of the first target area is less than a preset threshold; and
in the case that the ratio of the first distance to the width of the first target area is less than the preset threshold, determining that the first distance satisfies the preset condition.

10. The method according to claim 8, wherein performing image deformation processing on the third target area comprises:
dividing the third target area into a first area and a second area based on a location relationship between the first target area and the second target area, wherein the first area corresponds to the first target area, and the second area corresponds to the second target area; and
performing image deformation processing on the first area according to a first deformation parameter, and performing image deformation processing on a second area according to the second deformation parameter.

11. An image processing apparatus, comprising: a processor and a memory configured to storing instructions executable by the processor, wherein the processor is configured to:
acquire a first image;
recognize a target object in the first image, acquire a first target area of the target object, and acquire a second target area associated with the first target area; and
perform image deformation processing on the first target area and simultaneously perform image deformation processing on the second target area to generate a second image.

12. The apparatus according to claim 11, wherein the processor is configured to performing image deformation processing on the first target area according to a first deformation parameter and simultaneously perform image deformation processing on the second target area according to a second deformation parameter, wherein the first deformation parameter has a deformation degree higher than that of the second deformation parameter.

13. The apparatus according to claim 12, wherein the second deformation parameter changes with a distance between a pixel point in the second target area and the first target area,
wherein if the distance between the pixel point in the second target area and the first target area is larger, the deformation degree represented by the second deformation parameter corresponding to the pixel point in the second target area is lower.

14. The apparatus according to claim 11, wherein the second target area comprises at least one limb area; and the at least one limb area has a limb area adjacent to the first target area,
wherein the first target area is a shoulder area, and the second target area is at least one of a waist area or a chest area; or
the first target area is a waist area, and the second target area is at least one of a chest area or a shoulder area.

15. The apparatus according to claim 11, wherein the processor is configured to recognize limb detection information of the target object in the first image, wherein the limb detection information comprises at least one of limb key point information or limb contour point information; and
determine a contour line of the first target area based on the limb contour point information corresponding to the first target area; determine a center line of the first target area based on the limb contour point information corresponding to the first target area; and
perform compression processing on the first target area along a direction from the contour line to the center line, or perform stretching processing on the first target area along a direction from the center line to the contour line.

16. The apparatus according to claim 11, wherein the processor is configured to perform grid division on the first image to acquire a plurality of grid control surfaces; perform image deformation processing on the first target area based on a first grid control surface corresponding to the first target area; and perform image deformation processing on the second target area based on a second grid control surface corresponding to the second target area.

17. The apparatus according to claim 11, wherein the processor is further configured to acquire a third target area of the target object, wherein the third target area comprises at least one of an arm area or a hand area; and to determine a first distance between the third target area and an edge of a limb area of the target object; and
determine whether the first distance satisfies a preset condition; and in the case that the first distance satisfies the preset condition, perform image deformation processing on the first target area and simultaneously perform image deformation processing on the second target area and the third target area, to generate the second image.

18. The apparatus according to claim 17, wherein the processor is configured to determine whether a ratio of the first distance to a width of the first target area is less than a preset threshold; and to, in the case that the ratio of the first distance to a width of the first target area is less than the preset threshold, determine that the first distance satisfies the preset condition.

19. The apparatus according to claim 17, wherein the processor is configured to divide the third target area into a first area and a second area based on a location relationship between the first target area and the second target area, wherein the first area corresponds to the first target area, and the second area corresponds to the second target area; and to perform image deformation processing on the first area according to a first deformation parameter, and perform image deformation processing on the second area according to a second deformation parameter.

20. A non-transitory computer-readable storage medium having a computer program stored thereon, wherein the program, when being executed by a processor, enables the processor to implement the following:
acquiring a first image;
recognizing a target object in the first image, acquiring a first target area of the target object, and acquiring a second target area associated with the first target area; and
performing image deformation processing on the first target area and simultaneously performing image deformation processing on the second target area, to generate a second image.
